(19) United States
(12) Patent Application Publication
(10) Pub. No.: US 2007/0199989 A1
(43) Pub. Date: Aug. 30, 2007

(54) Combined machine identification and diagnosis device

(75) Inventors: Richard W. Piety, Knoxville, TN (US); Thomas E. Nelson, Knoxville, TN (US)

Correspondence Address: LUEDEKA, NEELY & GRAHAM, P.C., P O BOX 1871, KNOXVILLE, TN, 37901, US

(73) Assignee: CSI Technology, Inc.

(21) Appl. No.: 11/363,339

(22) Filed: Feb. 27, 2006

(51) Int. Cl. G06K 7/00; G06K 7/08

(52) U.S. Cl. 235/438; 235/451

(57) ABSTRACT

An apparatus that combines an RFID-like machine configuration reader with a device for acquiring machine diagnostic information. The apparatus includes an RFID-like communicator with an antenna and a machine diagnostic sensor, with the RFID-like communicator and the machine diagnostic sensor being substantially combined in a single housing. The apparatus is generally used with a portable data processor. The machine diagnostic sensor may be a thermal sensor, a vibration sensor, a flux sensor, or any other diagnostic sensor used in analysis of machine health. Electromagnetic interference shielding material may be disposed between the RFID-like communicator antenna and the machine diagnostic sensor to prevent electromagnetic interference between the RFID-like communicator and the machine diagnostic sensor. A method of diagnosing the condition of a machine using a combined RFID-like machine configuration communicator and machine diagnostic sensor is provided where the machine has an RFID-like transponder tag and an inspection point. The combined diagnostic reader is positioned in a first orientation where the RFID-like machine configuration communicator is in operative communication with the RFID-like transponder tag to read machine configuration date, and then the diagnostic reader is positioned in a second orientation where the machine diagnostic sensor is proximate to the inspection point to acquire machine diagnostic information.

### FIELD

This invention relates to the field of inspection of machinery using electronic testing devices. More particularly, this invention relates to devices that combine the automated acquisition of machine configuration information (such as machine identity and operational characteristics) with the automated acquisition of machine diagnostic information.

### BACKGROUND

In machine diagnostic testing it is desirable to provide a means of electronically recording machine configuration information (such as machine make, model, serial number, and operational parameters) in conjunction with the recording of machine diagnostic information (such as operating speed, temperature, vibration, and electromagnetic flux). Various systems have been developed in attempts to automate the acquisition of machine configuration information in conjunction with the collection of machine diagnostic information. However, these prior systems have been limited in the quantity of machine configuration information that can be stored and retrieved during a diagnostic test. Furthermore, prior systems typically require that the source of the machine configuration information (e.g., the barcode, chip, or other configuration digital storage medium) be located in the immediate vicinity of the machine diagnostic test point. This constraint significantly limits the deployment of these prior art systems because often the most preferred test point is at a location where it is inconvenient or impossible to co-locate the machine configuration digital storage medium. Furthermore, in many applications it is desirable to provide multiple test points on the same machine. Previously this has generally required that machine configuration information be duplicated in the immediate vicinity of each test point. This duplication adds undesirable expense, complexity, and the potential for inconsistency between data records.

Many of these problems could potentially be overcome by the use of Radio Frequency Identification (RFID) systems for acquiring machine configuration information. However, past practice has generally avoided the use of RFID systems in conjunction with the acquisition of machine diagnostic test equipment primarily because of problems with electromagnetic interference between the RFID system and the diagnostic test sensors, and problems with interference of the metal components of machinery with RFID signals. What are needed therefore are equipment designs and operational methods that provide a practical use of RFID-like systems for acquiring machine configuration information in conjunction with the acquisition of machine diagnostic test equipment.

### SUMMARY

The present invention provides a diagnostic reader for use on a machine having an RFIS transponder tag storing machine configuration information. The diagnostic reader comprises a housing having an attachment mechanism for removably affixing the diagnostic reader to the machine. The diagnostic reader further comprises an RFIS communicator having an antenna and a transmitter and a receiver and a processor. The transmitter and the receiver are each in operative communication with the antenna and with the processor, and the transmitter and the receiver are each under the control of the processor for sending an interrogation message to the RFIS transponder tag and for receiving the machine configuration information from the RFIS transponder tag. The diagnostic reader further comprises a machine diagnostic sensor disposed in the housing. The machine diagnostic sensor has a transducer for converting a physical characteristic of the machine into a signal representing machine diagnostic information when the diagnostic reader is affixed to the machine using the attachment mechanism.

A method of diagnosing the condition of a machine using a diagnostic reader is provided, where the machine has an RFIS transponder tag, and the machine has an inspection point. The method comprises a step of positioning the diagnostic reader in a first orientation wherein the RFIS communicator is in operative communication with the RFIS transponder tag. The method continues with activating the RFIS communicator, and then electronically interrogating the RFIS transponder tag to acquire machine configuration information. The method proceeds with positioning the diagnostic reader in a second orientation wherein the machine diagnostic sensor is proximate to the inspection point, and then activating the machine diagnostic sensor. The method concludes by acquiring machine diagnostic information from the machine.

### BRIEF DESCRIPTION OF THE DRAWINGS

Further advantages may be apparent by reference to the detailed description in conjunction with the figures, wherein elements are not to scale so as to more clearly show the details, wherein like reference numbers indicate like elements throughout the several views, and wherein:

FIG. 1 is a schematic diagram of a machine testing system for use with a machine having an RFID-like transponder tag, including a schematic cross sectional side view and end view of a diagnostic reader.

FIG. 2 is a schematic diagram of an RFID-like communicator for reading (and optionally writing) information from (and optionally to) an RFID-like transponder tag.

FIG. 3 is a schematic diagram of a transponder tag.

FIG. 4 is a pictorial illustration of a diagnostic reader connected to a portable data processor.

FIG. 5 is a flow chart of a method of automating the acquisition of machine configuration information in conjunction with the acquisition of machine diagnostic information.

### DETAILED DESCRIPTION

This application is related to U.S. patent application Ser. No. ______, “Belt Pack Accessory for Machine Condition Monitoring” by Piety and Nelson, filed concurrently herewith and incorporated in its entirety by reference.

Many of the problems associated with the aforementioned background art and problems with respect to the adaptation of RFID technology for the acquisition of machine configuration information in conjunction with the use of machine diagnostic test equipment are overcome by RFID-like Radio Frequency Information System (“RFIS”) devices described herein. As used herein the term “RFIS” encompasses both “standard” RFID communication systems (that conform to national or international standards) as well as vendor-proprietary RFID systems. While most present-day RFID readers and transponders use either inductive coupling or propagation coupling for communication, as used herein the term “RFIS” in association with readers and transponders encompasses such RFID readers and transponders, and it also encompasses radio frequency readers and transponders that employ other electronic coupling mechanisms such as capacitive coupling. While most present-day RFID transponders use silicon-based microcircuits for information storage, as used herein the term “RFIS” in association with transponders encompasses such RFID transponders and it also encompasses more exotic radio frequency transponder data storage systems such as surface acoustic wave tags that use a lithium niobate crystal in place of a silicon chip. While most present-day RFID readers, writers, and transponders communicate at a specific frequency and protocol to read, write, or acquire static data, as used herein the term “RFIS” in association with readers, writers, and transponders encompasses such RFID readers, writers, and transponders and it also encompasses “smart” radio frequency readers, writers and transponders that dynamically adapt their frequencies and protocols to exchange information.

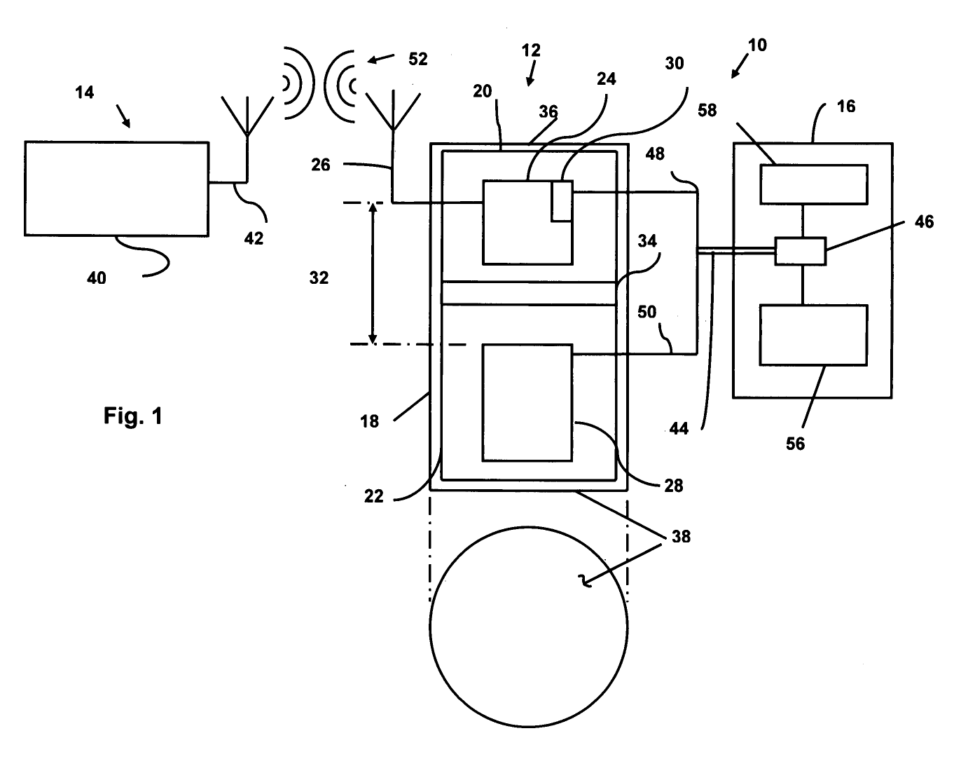

One embodiment of such systems is presented in FIG. 1 which illustrates a machine testing system 10. Machine testing system 10 includes an apparatus that combines an RFIS reader with a device for acquiring machine diagnostic information. Such apparatuses are hereinafter referred to as “diagnostic readers.” Machine testing system 10 includes diagnostic reader 12 for reading machine configuration information and for acquiring machine diagnostic information. Machine testing system 10 also includes an RFIS transponder tag 14 and a portable data processor 16.

Diagnostic reader 12 includes a housing 18 having a first interior portion 20 and a second interior portion 22. In some embodiments, such as depicted in FIG. 1, first interior portion 20 and second interior portion 22 are physically separate spaces within the housing 18. In some embodiments first interior portion 20 and second interior portion 22 may be adjoining portions of the housing 18 or may be separate portions of a common interior space in the housing 18. Within the first interior portion 20 there is an RFIS communicator 24 that is in operative communication with a communicator antenna 26. It shall be understood that the term “in operative communication” refers to direct or indirect communication of data between a first and a second hardware element either directly or through one or more intervening elements. In some embodiments RFIS communicator 24 may be a combined RFIS reader and RFIS writer, while in other embodiments RFIS communicator 24 is only an RFIS reader. In the embodiment of FIG. 1, communicator antenna 26 is exterior to housing 18, but in alternative configurations communicator antenna 26 may be enclosed within or integral with the housing 18.

A diagnostic sensor 28 is disposed within the second interior portion 22 of the housing 18. Diagnostic sensor 28 is a transducer, meaning a device that that detects and measures a physical phenomenon and generates an electronic signal representative of the measurement. Diagnostic sensor 28 may be a thermal sensor, a vibration sensor, a flux sensor, or any other diagnostic sensor used in analysis of machine health.

A significant potential problem with sensor 28 is interference between (a) RFIS communicator 24 and (b) the physical phenomenon being measured and/or its electronic representation generated by diagnostic sensor 28. That is, the RFIS communicator 24 may interfere with the physical phenomenon being measured and/or its electronic representation generated by diagnostic sensor 28, or the physical phenomenon being measured and/or its electronic representation generated by diagnostic sensor 28 may interfere with RFIS communicator 24. Various mechanisms may be provided to mitigate these potential interferences. For example, a switch 30 may be provided to activate RFIS communicator 24 and to deactivate RFIS communicator 24 at times when it might interfere with diagnostic sensor 28. Also, spatial separation 32 may be provided between the communicator antenna 26 and diagnostic sensor 28 in order to mitigate interference between these devices. In some embodiments shielding material 34 may be disposed between communicator antenna 26 and diagnostic sensor 28 in order to mitigate interference between the devices. In some embodiments shielding material 34 may include electromagnetic interference (EMI) shielding material, and may consist of an electrical conductor such as an aluminum sheet, a copper mesh, or a carbon/graphite barrier. In some embodiments shielding material 34 may include magnetic shielding material such as ferromagnetic material.

In FIG. 1, the diagnostic reader (i.e., diagnostic reader 12) is shaped substantially as a right circular cylinder. In alternative embodiments the sensor housing 18 of a diagnostic reader may have alternative shapes, but the preferred shape is in the form of a right cylinder, (although not necessarily circular). In preferred embodiments the housing 18 has opposing ends (e.g., 36 and 38 in FIG. 1) and preferably the first interior portion (e.g., 20) and the second interior portion (e.g., 22) of the housing (e.g., 18) are disposed as shown at opposing ends (e.g., 36 and 38) of the cylindrical shape.

As previously noted, machine testing system 10 also includes an RFIS transponder tag 14. RFIS transponder tag 14 may be an active or a passive RFIS transponder device. RFIS transponder tag 14 includes transponder circuitry 40 and a transponder antenna 42 that is in operative communication with transponder circuitry 40.

Also as previously noted, machine testing system 10 incorporates a portable data processor 16. Portable data processor 16 may be, for example, a general purpose computer (such as a desktop or laptop computer), or a personal digital assistant (PDA) device, or a special purpose electronic data processor. The portable data processor 16 is configured to control the operation of the diagnostic reader 12 and to record machine configuration information and machine diagnostic information acquired by the diagnostic reader 12. Portable data processor 16 is in operative communication with RFIS communicator 24 and diagnostic sensor 28. In the embodiment of FIG. 1, operative communication between portable data processor 16 and RFIS communicator 24 and diagnostic sensor 28 is achieved through diagnostic reader communication link 44. Diagnostic reader communication link 44 is in operative managed by processor 46 in portable data processor 16. In the embodiment of FIG. 1, diagnostic reader communication link 44 is a wired link, but in alternative embodiments diagnostic reader communication link 44 may be a wireless link. Diagnostic reader communication link 44 includes an RFIS branch 48 and a diagnostic sensor branch 50.

In operation, before conducting a diagnostic test on a machine an operator positions the communicator antenna 26 near the location of the transponder antenna 42 of the RFIS transponder tag 14 that is associated with and preferably mounted on the machine. The operator then uses an input device 56 on the portable data processor 16 to direct the processor 46 in the portable data processor 16 to send instructions over diagnostic reader communication link 44, branch 48 to the RFIS communicator 24. The input device 56 may be a button, a switch, a keyboard, or similar device on the portable data processor 16, or the input device 56 may be a communication link from another electronic device. The instructions direct RFIS communicator 24 to acquire configuration information from the RFIS transponder tag 14 associated with the machine. Configuration information may include machine identification information, historical test results, normal operating limits, a certification tag attesting to the machine's compliance with specifications, and other data representing characteristics of the machine. RFIS communicator 24 then sends an interrogation message over communicator wireless link 52 to RFIS transponder tag 14 through transponder antenna 42. If RFIS transponder tag 14 is a passive device, the interrogation message includes sufficient power transmission to enable RFIS transponder 14 to use a portion of the power to transmit a reply. The RFIS transponder tag 14 receives the interrogation message through RFIS antenna 42 and then transmits the machine configuration information that has been stored in the RFIS transponder tag 14 over transponder wireless link 52. RFIS communicator receives the machine configuration information through communicator antenna 26 and passes the information to the portable data processor 16. Typically, the portable data processor 16 then used a display 58 on portable data processor 16 to advise the operator whether the machine configuration information is acceptable, meaning whether the information is of the expected format and content. Display 58 may be a series of indicator lights (e.g., green, yellow, red), a text or graphic electronic screen, or a similar device.

Presuming that the machine configuration information is acceptable, the operator then positions the diagnostic sensor 28 at an appropriate test point on the machine and uses input device 56 to instruct the processor 46 of the portable data processor 16 to use diagnostic reader communication link 44, branch 50, to acquire machine diagnostic information from the machine. The form of machine diagnostic information depends upon the particular diagnostic sensor being used. In some embodiments, the machine diagnostic information is in digital form, but in some embodiments the machine diagnostic information may include analog signals that are converted to digital data by the portable data processor 16. The machine diagnostic information is transmitted from the diagnostic sensor 28 to the processor 46 of the portable data processor 16 over diagnostic reader communication link 44, branch 50. The processor 46 of the portable data processor 16 may advise the operator of the results of the diagnostic information using the display 58 on the portable data processor 16.

Optionally then, portable data processor 16 may use the display 58 to instruct the operator to position the communicator antenna 26 in proximity to the transponder antenna 42. Completion of that action may be confirmed manually by the operator or automatically by having the RFIS communicator 24 send an interrogation message to the RFIS transponder tag 14 and confirming receipt thereof. In this optional process, the processor 46 of the portable data processor 16 then sends machine configuration information over diagnostic reader communication link 44, branch 48 to RFIS communicator 24, and RFIS communicator 24 sends an update message containing updated machine configuration information to RFIS transponder tag 14 over communicator wireless link 52. If RFIS transponder tag 14 is a passive device, the update message includes a power transmission to enable RFIS transponder 14 to record the updated machine configuration information.

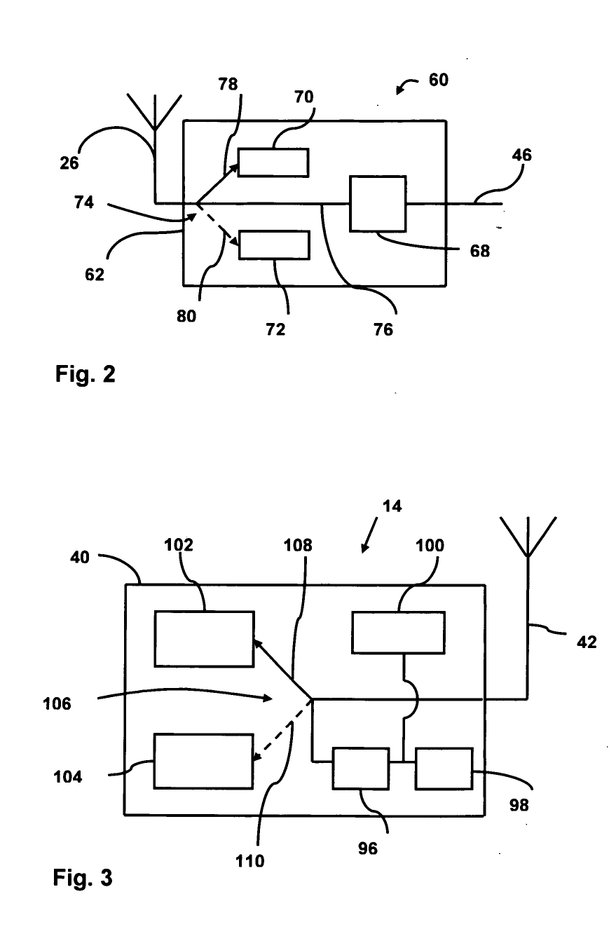

Further details of one embodiment of an RFIS communicator 60 are shown in FIG. 2. RFIS communicator 60 is different from RFIS communicator 24 in FIG. 1 in that RFIS communicator 24 has a switch 30 whereas RFIS communicator 60 does not have a switch like switch 30. RFIS communicator 60 has transponder circuitry 62 and a communicator antenna 26. RFIS communicator 60 communicates with a portable data processor (e.g., 16 in FIG. 1) through communication link branch 46. Transponder circuitry 62 includes a processor 68, a transmitter 70, and a receiver 72. Optionally, for half-duplex RFIS modes, a switch 74 that is operatively connected to processor 68 through communication link 76 may be provided to control when RFIS communicator 60 is in a transmit mode and when it is in a receive mode. When switch branch 78 is closed RFIS communicator 60 is in a transmit mode; when switch branch 80 is closed RFIS communicator 60 is in a receive mode. In embodiments employing a switch 74, preferably switch branch 80 is not closed when switch branch 78 is closed because signals from the transmitter 70 (if received by receiver 72) could overwhelm receiver 72.

FIG. 3 illustrates details of an embodiment of an RFIS transponder tag 14. RFIS transponder tag has transponder circuitry 40 and a transponder antenna 42. Transponder circuitry 40 includes a processor 96, a memory 98, and optionally a power circuit 100. If RFIS transponder tag 14 is a passive device, power circuit 100 may store energy from interrogation or updating messages from an RFIS communicator (e.g., 24 of FIG. 1 or 60 of FIG. 2) for use in transmitting (and optionally storing) machine configuration information. RFIS transponder tag 14 also includes a modulator 102 and a demodulator 104. The modulator 102 is a special form of a transmitting device that converts data from the processor 96 to changes in circuit characteristics (e.g., input impedance) that are reflected in radio frequency (RF) signals transmitted over transponder antenna 42. These data, for example, may be acknowledgment of received commands or data read from the memory 98. The demodulator 104 is a special form of a receiving device that converts input RF signals to digital data, and typically also generates a synchronous system clock signal. A switch 106 may be used to set RFIS transponder 14 in a transmit mode (when switch branch 108 is closed) and in a receive mode (when switch branch 110 is closed.)

The construction of a machine testing system may incorporate commercially available components. For example, an RFID disk transponder such as a 30 mm disk transponder from Texas Instruments (P/N RI-TRP-R9QL or P/N RI-TRP-S9QL) may be used in an RFIS transponder tag. However, a metal mounting RFID transponder tag, such as a mount-on-metal transponder from Texas instruments (P/N RI-TRP-R9VS or P/N RI-TRP-W9VS), is preferred because such transponders are specifically designed to reduce electromagnetic interference from metal in machinery on which the transponder may be mounted. A commercial RFID integrated circuit, such as an LF Base Station IC from Texas Instruments (P/N TMS3705ADR) together with an RFID stick antenna such as a Series 2000 stick antenna from Texas Instruments (P/N RI-ANT-S01C or PIN RI-ANT-S02C) may form the basis of an RFIS communicator. A vibration sensor, such as single axis or multi-axis accelerometers available from Emerson Process Management may be used as the machine diagnostic sensor. As previously suggested, a general purpose computer (preferably a laptop), a personal digital assistant (PDA) device, or a special purpose electronic data processor may form the basis of an RFIS portable data processor.

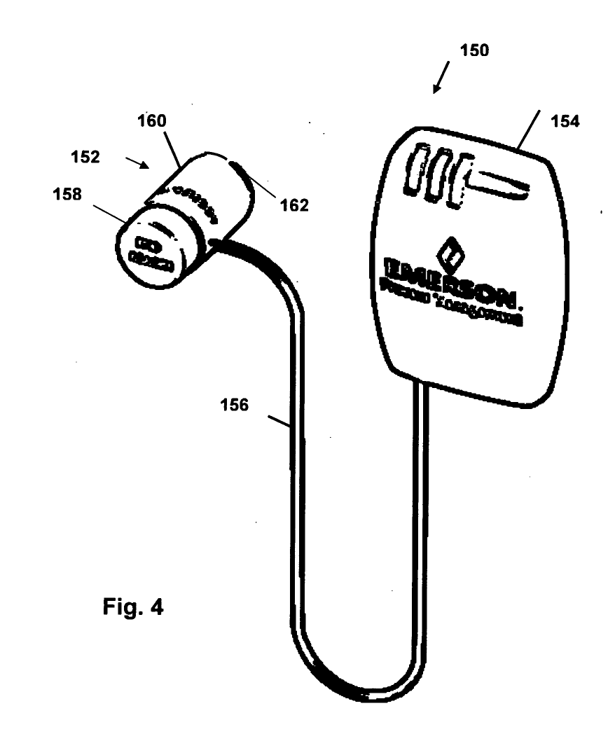

FIG. 4 presents a pictorial illustration of certain components of a preferred embodiment of a machine testing system 150. Machine testing system 150 includes a diagnostic reader 152 (such as diagnostic reader 12 of FIG. 1) and a portable data processor 154 (such as portable data processor 16 of FIG. 1) that are connected by a diagnostic reader communication link 156 (such as diagnostic reader communication link 44 of FIG. 1). Diagnostic reader 152 includes an RFIS communicator 158 (such as RFIS communicator 24 of FIG. 1) and a diagnostic sensor 160 (such as diagnostic sensor 28 of FIG. 1). An attachment device 162 is provided to affix the diagnostic reader 152 to a machine being tested.

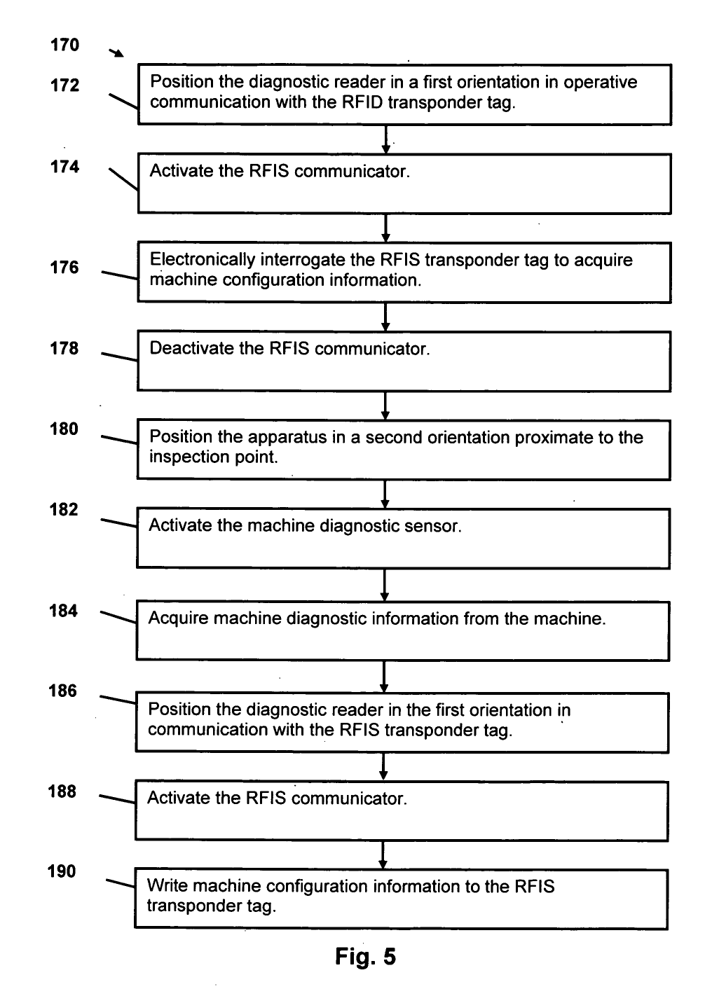

FIG. 5 illustrates a method 170 of diagnosing the condition of a machine using a diagnostic reader, where the machine has an RFIS transponder tag and the machine has an inspection point. Method 170 begins with step 172 in which RFIS communicator is positioned to be in operative communication with the RFIS transponder tag. The method continues with step 174 in which the RFIS communicator is activated. In step 176 the RFIS transponder tag is interrogated to acquire machine configuration information. The method 170 may then invoke optional step 178 in which the RFIS communicator is deactivated. In step 180 the diagnostic reader is positioned in a second orientation proximate to the inspection point. The machine diagnostic sensor is activated in step 182 and then machine diagnostic information is acquired from the machine in step 184.

In some embodiments where the RFIS communicator is both a reader and a writer, the method may continue with steps 186, 188, and 190. In step 186 the diagnostic reader is positioned in the first orientation (so that it is in operative communication with the RFIS transponder tag). Then in step 188 the RFIS communicator is activated, and per step 190 machine configuration information is written to the RFIS transponder tag. In some embodiments, machine configuration information that is written to the RFIS transponder tag may include a portion of the machine diagnostic information acquired in step 184, and may include summary information about the operational status of the machine.

It is to be understood that in some embodiments and applications the diagnostic reader may be positioned at a single location on a machine that is both in operative communication with the RFIS transponder tag and proximate to the inspection point, so that step 180 does not require a repositioning of the diagnostic reader from the position established in step 172. In other embodiments the combined RFIS communicator and machine diagnostic sensor is positioned at a first position in step 172 and the repositioned at a second position in step 180 (and then repositioned again in step 186 to the first position, if step 186 is employed).

The foregoing descriptions of embodiments of this invention have been presented for purposes of illustration and exposition. They are not intended to be exhaustive or to limit the invention to the precise forms disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A diagnostic reader for use on a machine having an RFIS transponder tag storing machine configuration information, the diagnostic reader comprising:
a housing having an attachment mechanism for removably affixing the diagnostic reader to the machine;
an RFIS communicator having an antenna and a transmitter and a receiver and a processor, the transmitter and the receiver each being in operative communication with the antenna and with the processor and the transmitter and the receiver each being under the control of the processor for sending an interrogation message to the RFIS transponder tag and for receiving the machine configuration information from the RFIS transponder tag;
a machine diagnostic sensor disposed in the housing, the machine diagnostic sensor having a transducer for converting a physical characteristic of the machine into a signal representing machine diagnostic information when the diagnostic reader is affixed to the machine using the attachment mechanism.

2. The diagnostic reader of claim 1 further comprising a diagnostic reader communication link for transferring at least a portion of the machine configuration information and at least a portion of the machine diagnostic information to a portable data processor.

3. The diagnostic reader of claim 1 wherein the housing has a first interior potion and a second interior portion, the transmitter and the receiver and the processor being disposed in the first interior portion, the machine diagnostic sensor being disposed in the second interior portion, and the attachment mechanism for removably affixing the diagnostic reader to the machine being adjacent to the second interior portion.

4. The diagnostic reader of claim 3 wherein the housing has a substantially cylindrical shape and the first interior portion and the second interior portion of the housing are disposed at opposing ends of the cylindrical shape.

5. The diagnostic reader of claim 1 wherein the RFIS communicator antenna and the machine diagnostic sensor are separated by a distance of at least approximately 1 cm.

6. The diagnostic reader of claim 1 further comprising shielding material disposed between the RFIS antenna and the machine diagnostic sensor.

7. The diagnostic reader of claim 1 wherein the RFIS communicator includes a switch for activation and deactivation of the RFIS communicator.

8. The diagnostic reader of claim 1 wherein the RFIS communicator is further configured for sending machine configuration information to the RFIS transponder tag under the control of the processor.

9. The diagnostic reader of claim 1 wherein the external attachment mechanism comprises a permanent magnet.

10. The diagnostic reader of claim 1 wherein the machine diagnostic sensor comprises a vibration sensor.

11. The diagnostic reader of claim 10 wherein the housing has a first interior potion and a second interior portion, the transmitter and the receiver and the processor being disposed in the first interior portion, the machine diagnostic sensor being disposed in the second interior portion, and the attachment mechanism for removably affixing the diagnostic reader to the machine being adjacent to the second interior portion, and the housing has a substantially cylindrical shape and first interior portion and the second interior portion of the housing are disposed at opposing ends of the cylindrical shape.

12. The diagnostic reader of claim 10 wherein the RFIS communicator antenna and the machine diagnostic sensor are separated by a distance of at least approximately 1 cm.

13. The diagnostic reader of claim 10 further comprising shielding material disposed between the first interior portion and the second interior portion of the housing.

14. The diagnostic reader of claim 10 wherein the RFIS communicator includes a switch for activation and deactivation of the RFIS communicator.

15. The diagnostic reader of claim 10 wherein the external attachment mechanism comprises a permanent magnet.

16. The diagnostic reader of claim 10 wherein the RFIS communicator is further configured for sending machine configuration information to the RFIS transponder tag under the control of the processor.

17. A method of diagnosing the condition of a machine using a diagnostic reader, the machine having an RFIS transponder tag, and the machine having an inspection point, the method comprising:
(a) positioning the diagnostic reader in a first orientation wherein the RFIS communicator is in operative communication with the RFIS transponder tag;
(b) activating the RFIS communicator;
(c) electronically interrogating the RFIS transponder tag to acquire machine configuration information;
(d) positioning the diagnostic reader in a second orientation wherein the machine diagnostic sensor is proximate to the inspection point;
(e) activating the machine diagnostic sensor;
(d) acquiring machine diagnostic information from the machine.

18. The method of claim 17 further comprising after step (c) a step (c′): deactivating the RFIS machine configuration communicator.

19. The method of claim 17 wherein the step (c) includes interrogating the RFIS transponder tag to acquire diagnostic history data regarding the machine.

20. The method of claim 17 wherein the method further comprises:
(e) positioning the diagnostic reader at the first orientation wherein the RFIS machine configuration communicator is in operative communication with the RFIS transponder antenna;
(f) activating the RFIS machine configuration communicator; and
(f) writing machine configuration information to the RFIS transponder tag.
